(19) United States
(12) Patent Application Publication
(10) Pub. No.: US 2019/0292106 A1
(43) Pub. Date: Sep. 26, 2019

(54) NANOLAMINATED MATERIAL, TWO-DIMENSIONAL MATERIAL AND PROCESS FOR PRODUCTION OF A MATERIAL

(71) Applicant: Johanna ROSÉN, Linköping (SE)

(72) Inventors: Johanna ROSÉN, Linköping (SE); Rahele MESHKIAN, Linköping (SE); Quanzheng TAO, Linköping (SE); Jun LU, Linköping (SE); Martin DAHLQVIST, Norrköping (SE); Per PERSSON, Linköping (SE)

(21) Appl. No.: 16/304,364

(22) PCT Filed: Jul. 7, 2016
(86) PCT No.: PCT/SE2016/050700

§ 371 Date: Nov. 26, 2018

(30) Foreign Application Priority Data
May 26, 2016 (SE) 1650730-3

(51) Int. Cl. C04B 35/626; C04B 35/56

(52) U.S. Cl. CPC C04B 35/62675; B82Y 30/00; C04B 35/56

(57) ABSTRACT

The disclosure relates to a nanolaminated material of the formula (M1_{x±β},M2_{y±ε})2−δA_{1-α}C_{1±ρ} wherein Ml is a first transition metal and M2 is a second transition metal. The M1 and M2 atoms are chemically ordered in relation to each other within the plane. The disclosure also relates to a process for producing a substantially two-dimensional material from said nanolaminated material, as well as a substantially two-dimensional material. The substantially two-dimensional material may comprise ordered vacancies or two transition metals which are chemically ordered.

### TECHNICAL FIELD

The present disclosure relates to a nanolaminated material with the formula (M1_{x±β},M2_{y±ε})_{2-δ}Al_{1-α}C_{1±ρ}, wherein M1 and M2 constitutes two different transition metals. The present disclosure further relates to a process for manufacturing a material comprising at least one layer constituting a substantially two-dimensional array of crystal cells. Furthermore, the present disclosure relates to a substantially two-dimensional material constituting a substantially two-dimensional array of crystal cells.

### BACKGROUND

So called MAX phases, or MAX phase alloys, constitute a class of materials with the formula Mₙ₊₁AXₙ where n=1 to 3, M constitutes at least one transition metal, A constitutes at least one A-group element, and X is at least one of C, N and O. MAX phases with compositions diverging from n being an integer are also known, and MAX phases with n above 3 have been reported in the literature. Thus, MAX phases may be more appropriately described with the formula M_{n+1-δ}A_{1-α}X_{n±ρ}, wherein n=1, 2, 3 or higher, δ≤0.2, α≤0.2 and ρ≤0.2, M is at least one transition metal, A is at least one A-group element, and X is at least one of C, N and O.

MAX phases are in the literature often divided into different classes of MAX phases depending on the relative amounts of the M, A and X elements and the most common classes constitute 211 MAX phases, 312 MAX phases and 413 MAX phases.

MAX phases have a layered hexagonal crystal structure with P6₃/mmc symmetry. Each unit cell comprises two formula units. Near-closed packed layers of the M-element(s) are interleaved with pure A-group element(s) layers, with the X-atoms filling the octahedral sites between the former. Therefore, MAX phases form laminated structures. These laminated structures have anisotropic properties as a result of the structure.

MAX phases possess unique properties combining ceramic and metallic properties. They are for example electrically and thermally conductive, resistant to thermal shock, plastic at high temperatures and readily machinable. Many MAX phases also have comparatively low weight, are corrosion resistant, and also have excellent creep and fatigue resistance. For said reason, MAX phases have previously been suggested for applications such as heating elements, gas burner nozzles in corrosive environments, high-temperature bearings as well in composites for dry drilling of concrete. MAX phases have also been proposed as coatings for electrical components, for example for fuel cell bipolar plates and electrical contacts.

MAX phases may also have other properties. For example, WO 2012/070991 A1 and WO 2015/065252 A1 discloses MAX phases having magnetic properties. The MAX phases comprise two transition metals, wherein one of the transition metals contributes to the magnetic properties and the other contributes to the ability to synthesize the MAX phase.

MAX phases may be synthesised by bulk synthesis wherein the constituent elements of the intended MAX phase are mixed in the intended amounts of the MAX phase and subjected to high temperature so as to form the MAX phase. Examples of such bulk synthesis methods include hot isostatic pressing (HIP), reactive sintering, self-propagating high temperature synthesis (SHS), and combustion synthesis. MAX phases may also be synthesised using thin film synthesis methods, such as by physical vapour deposition (PVD) or chemical vapour deposition (CVD).

It is previously known to synthesise two-dimensional materials, also known as MXenes, from MAX phases. MXenes are a class of two-dimensional inorganic compounds which consist of a few atoms thick layers of transition metal carbides or carbonitrides. MXenes are often described with the formula Mₙ₊₁Xₙ. However, since the surfaces of MXene generally are terminated by functional groups, a more correct description is the formula Mₙ₊₁XₙTₛ, where Tₛ is a functional group such as O, F or OH.

The synthesis of MXenes comprises etching of various MAX phases to thereby remove the A-atoms of the MAX phase. For example, the MAX phase M₂AlC (M denominating a transition metal) may be etched in hydrofluoric acid (HF), resulting in removal of the Al-layer and formation of two dimensional M₂C sheets. Specific examples of MXenes that have been previously synthesized include Ti₂C, V₂C, Nb₂C, Ti₃C₂, Ti₃CN, Nb₄C₃ and Ta₄C₃.

For example, Naguib et al., “Two-Dimensional Nanocrystals Produced by Exfoliation of Ti₃AlC₂”, Advanced Materials, 2011, 23, 4248-4253, reported synthesis of a two dimensional material starting from the MAX phase Ti₃AlC₂. They extracted the Al from Ti₃AlC₂ by use of hydrofluoric solution and thereby arrived at isolated layers of Ti₃C₂.

Furthermore, WO 2014/088995 A1 discloses compositions comprising free standing and stacked assemblies of two-dimensional crystalline solids. The compositions comprise at least one layer having first and second surfaces, each layer comprising a substantially two-dimensional array of crystal cells, each crystal cell having an empirical formula of Mₙ₊₁Xₙ, such that X is positioned within an octahedral array of M. M is at least one Group IIIB, IVB, VB or VIB metal, X is C and/or N and n=1, 2 or 3. The compositions may be produced by removing substantially all of the A atoms from a MAX-phase composition having an empirical formula of Mₙ₊₁AXₙ, wherein M is at least one Group IIIB, IVB, VB or VIB metal, A is an A-group element, X is C and/or N, and n=1, 2 or 3.

Horlait et al., “Attempts to synthesise quaternary MAX phases (Zr,M)₂AlC and Zr₂(Al, A)C as a way to approach Zr₂AlC”, Materials Research Letters, 2016, reported synthesis attempts of numerous (Zr_{0.75},M_{0.25})₂AlC and (Z_{0.5},M_{0.5})₂AlC compositions with M=Mo, Ti or Cr by pressureless heating under Ar. It was concluded that MAX phases were not obtained for (Zr_{0.75},M_{0.25})₂AlC and (Z_{0.5},M_{0.5})₂AlC, but a combination of ZrC and other crystalline phases where obtained.

### SUMMARY

The object of the present invention is to provide new tailored nanolaminated materials of the MAX phase type which may enable new possibilities for said type of material. More specifically, the object of the present invention is to provide new nanolaminated materials comprising two transition metals and which demonstrate chemical in-plane ordering of the transition metals.

The object is achieved by a nanolaminated material according to independent claim 1.

The nanolaminated material has the formula (M1_{x±β},M2_{y±ε})_{2-δ}Al_{1-α}C_{1±ρ}, wherein
β is 0 to ≤0.1,
ε is 0 to ≤0.1,
δ is 0 to ≤0.2,
α is 0 to ≤0.2,
ρ is 0 to ≤0.2,
x+y=1,
x is between 0.60 and 0.75, preferably wherein x is between 0.65 and 0.69,
M1 is a first transition metal and M2 is a second transition metal, and wherein either
   M1 is selected from a first group of transition metals consisting of Cr, Mo, Nb, Ta, Ti, V and W, and M2 is selected from a second group of transition metals consisting of Ce, Er, Hf, Ho, Sc, Y and Zr; or
   M1 is Ti and M2 is selected from the group consisting of Nb, Ta, V and W; or
   M1 is Sc and M2 is either Mo or W; or
   M1 is Cr and M2 is Ta; or
   M2 is Ti and M1 is selected from the group consisting of Cr, Nb, Ta and V.

The nanolaminated material according to the present invention is thus a quaternary MAX phase alloy of the 211 type, wherein A is Al and X is C. The nanolaminated material has in-plane chemical ordering of the transition metals M1 and M2. That is, in the M-plane of the MAX phase alloy, the M1 and M2 atoms are ordered in relation to each other in contrast to randomly distributed within the M-plane. The nanolaminated material according to the present invention may be used in synthesis of MXenes.

According to a first aspect, M1 is selected from the first group of transition metals consisting of Cr, Mo, Nb, Ta, Ti, V and W, and M2 is selected from the second group of transition metals consisting of Ce, Er, Hf, Ho, Sc, Y and Zr. Thereby, in the nanolaminated material, the M2 atoms may have a greater atomic radius than the M1 atoms.

The second group of transition metals may according to one embodiment consist of Ce, Er, Ho, Sc, Y and Zr. Preferably, the second group of transition metals consists of Sc, Y and Zr. Furthermore, the first group of transition metals may for example consist of Cr, Mo, Nb, V and W.

The nanolaminated material may for example be selected from the group consisting of: (Mo_{x±β}Sc_{y±ε})_{2-δ}Al_{1-α}C_{1±ρ}, (W_{x±β}Sc_{y±ε})_{2-δ}Al_{1-α}C_{1±ρ}, (W_{x±β}Sc_{y±ε})_{2-δ}Al_{1-α}C_{1±ρ}, and (V_{x±β}Sc_{y±ε})_{2-δ}Al_{1-α}C_{1±ρ}. These nanolaminated materials have inter alia been found to be highly suitable for synthesis of substantially two-dimensional materials, and may for example result in substantially two-dimensional materials with ordered vacancies.

In the nanolaminated material according to the present invention, x is preferably 2/3.

According to one embodiment of the nanolaminated material, M1 is Ti and M2 is selected from the group consisting of Ce, Er, Hf, Ho, Nb, Sc, Ta, V, W, Y and Zr. Thereby, a nanolaminated material with in-plane chemical ordering and comprising Ti is achieved.

According to another aspect of the nanolaminated material, M1 is Sc, M2 is either Mo or W, and x is from 0.60 to 0.67. Preferably, x is 0.60.

The present invention also relates to a process for manufacturing a material comprising at least one layer constituting a substantially two-dimensional array of crystal cells. The process comprises the following steps:
a. preparing a nanolaminated material with the formula (M1_{x±β},M2_{y±ε})_{2-δ}Al_{1-α}C_{1±ρ}, wherein
   β is 0 to ≤0.1,
   ε is 0 to ≤0.1,
   δ is 0 to ≤0.2,
   α is 0 to ≤0.2,
   ρ is 0 to ≤0.2,
   x+y=1,
   x is between 0.60 and 0.75, preferably wherein x is between 0.65 and 0.69, M1 is a first transition metal and M2 is a second transition metal, and wherein either
      M1 is selected from a first group of transition metals consisting of Cr, Mo, Nb, Ta, Ti, V and W, and M2 is selected from a second group of transition metals consisting of Ce, Er, Hf, Ho, Sc, Y and Zr; or
      M1 is Ti and M2 is selected from the group consisting of Nb, Ta, V and W; or
      M1 is Cr and M2 is Ta; or
      M2 is Ti and M1 is selected from the group consisting of Cr, Nb, Ta and V;
b. selectively etching the nanolaminated material so as to remove substantially all of the Al atoms and optionally substantially all of the M2 atoms, thereby obtaining a plurality of substantially two-dimensional layers each having a formula (M1_{x±β},η_{y±ε})_{2-δ}C_{1±ρ} wherein η is either M2 or a vacancy, and wherein each substantially two-dimensional layer comprises a surface termination Tₛ resulting from the etching, and
c. optionally thereafter isolating at least one first layer of the plurality of substantially two-dimensional layers.

In step a. given above, a nanolaminated material with the formula (M1_{x±β},M2_{y±ε})_{2-δ}Al_{1-α}C_{1±ρ}, wherein M1 is selected from the first group of transition metals consisting of Cr, Mo, Nb, Ta, Ti, V and W, and M2 is selected from the second group of transition metals consisting of Ce, Er, Hf, Ho, Sc, Y and Zr may according to an embodiment be prepared.

According to one alternative preferred embodiment, in step a. given above, a nanolaminated material with the formula (M1_{x±β},M2_{y±ε})_{2-δ}Al_{1-α}C_{1±ρ} wherein M2 is either Sc or Y is prepared, and the process further comprises either in step b. or in a separate step, selectively etching so as to remove M2 atoms from the nanolaminated material, thereby obtaining a material comprising at least one layer constituting a substantially two-dimensional array or crystal cells, the at least one first layer comprising ordered vacancies.

According to another alternative preferred embodiment, in step a. given above, a nanolaminated material with the formula (M1_{x±β},M2_{y±ε})_{2-δ}Al_{1-α}C_{1±ρ} wherein M2 is Ce, Er, Hf, Ho or Zr is provided, and in the plurality of substantially two-dimensional layers each having a formula (M1_{x±β},η_{y±ε})_{2-δ}C_{1±ρ} obtained in step b., η is M2. That is, the M2 atoms are not etched from the nanolaminated material.

The present invention further relates to a substantially two-dimensional material obtainable by means of the process as disclosed above.

A substantially two-dimensional material according to the present invention comprises a layer having an empirical formula (M1_{x±β},η_{y±ε})_{2-δ}C_{1±ρ} and constituting a substantially two-dimensional array of crystal cells, wherein
β is 0 to ≤0.1,
ε is 0 to ≤0.1,
δ is 0 to ≤0.2,
ρ is 0 to ≤0.2,
x+y=1,
x is between 0.60 and 0.75, preferably wherein x is between 0.65 and 0.69
M1 and η are arranged within the crystal cells such as together forming an essentially octahedral array and C is positioned within said essentially octahedral array,
η is either M2 or a vacancy,
and wherein either:
   M1 is selected from a first group of transition metals consisting of Cr, Mo, Nb, Ta, Ti, V and W, and η is a vacancy; or
   M1 is selected from a first group of transition metals consisting of Cr, Mo, Nb, Ta, Ti, V and W, η is M2, and M2 is selected from a group consisting of Ce, Er, Hf, Ho and Zr; or
   M1 is Ti, η is M2, and M2 is selected from the group consisting of Nb, Ta, V and W; or
   M1 is Cr, η is M2, and M2 is Ta; or
   η is M2, M2 is Ti, and M1 is selected from the group consisting of Cr, Nb, Ta and V.

Preferably, in the empirical formula (M1_{x±β},η_{y±ε})_{2-δ}C_{1±ρ}, x is ⅔.

According to a preferred embodiment, the layer of the substantially two-dimensional material has a formula selected from the group consisting of:
(Mo_{x±β},η_{y±ε})_{2-δ}C_{1±ρ} wherein η is a vacancy or Y;
(W_{x±β},η_{y±ε})_{2-δ}C_{1±ρ} wherein η is a vacancy; and
(V_{x±β},η_{y±ε})_{2-δ}C_{1±ρ} wherein η is a vacancy.

In the substantially two-dimensional material, the layer may have the formula (M1_{x±β},M2_{y±ε})_{2-δ}C_{1±ρ}, wherein M2 is either Ce, Er, Hf, Ho or Zr.

The layer of the substantially two-dimensional material has a first surface and a second surface, and may comprise a surface termination Tₛ. The surface termination may result from the etching process or be a surface termination achieved in a processing step subsequent to the etching step.

The present invention further relates to a stacked assembly comprising a plurality of layers wherein at least one of the layers constitutes a substantially two-dimensional material as described above.

The stacked assembly may preferably comprise more than one layer of the substantially tow-dimensional material. The stacked assembly may further comprise layers of other compositions or materials.

Moreover, the present invention also relates to an energy storage device comprising a substantially two-dimensional material as disclosed above.

The present invention further relates to a composite comprising a substantially two-dimensional material as disclosed above.

Moreover, the present invention relates to a material comprising at least one layer constituting a substantially two-dimensional array of crystal cells, the material obtainable through the process as disclosed above.

### BRIEF DESCRIPTION OF DRAWINGS

FIG. 1 schematically illustrates a side view of the atomic structure of a conventional 211 MAX phase

FIG. 2a schematically illustrates a side view of the atomic structure of a nanolaminated material according to one exemplifying embodiment of the present invention

FIG. 2b schematically illustrates a perspective view of the atomic structure of a nanolaminated material shown in FIG. 2a

FIG. 3 schematically illustrate a process for manufacturing a material comprising at least one layer constituting a substantially two-dimensional array of crystal cells

FIG. 4a schematically illustrates a side view of the atomic structure of a nanolaminated material of FIG. 2a

FIG. 4b schematically illustrates a side view of the atomic structure of a stacked assembly obtained through etching of the nanolaminated material as illustrated in FIG. 4a according to one embodiment

FIG. 4c schematically illustrates a top view of an isolated substantially two-dimensional layer obtained from the stacked assembly as illustrated in FIG. 4b

FIG. 4d schematically illustrates a side view of the atomic structure of a stacked assembly obtained through etching of the nanolaminated material as illustrated in FIG. 4a according to another embodiment

FIG. 4e schematically illustrates a top view of an isolated substantially two-dimensional layer obtained from the stacked assembly as illustrated in FIG. 4d

FIG. 5a illustrate XRD spectra for (Mo_{2/3}Y_{1/3})₂AlC powder

FIG. 5b constitutes a photograph from STEM of (Mo_{2/3}Y_{1/3})₂AlC

FIG. 6a illustrate XRD spectra for (V_{2/3}Zr_{1/3})₂AlC powder

FIG. 6b constitutes a photograph from STEM of (V_{2/3}Zr_{1/3})₂AlC

FIG. 7a illustrate XRD spectra for (Cr_{2/3}Sc_{1/3})₂AlC powder

FIG. 7b constitutes a photograph from STEM of (Cr_{2/3}Sc_{1/3})₂AlC

FIG. 8a illustrate XRD spectra for (Cr_{2/3}Y_{1/3})₂AlC powder

FIG. 8b constitutes a photograph from STEM of (Cr_{2/3}Y_{1/3})₂AlC

FIG. 9a illustrate XRD spectra for (V_{2/3}Sc_{1/3})₂AlC powder

FIG. 9b constitutes a photograph from STEM of (V_{2/3}Sc_{1/3})₂AlC

FIG. 10a illustrate XRD spectra for (W_{2/3}Sc_{1/3})₂AlC powder

FIG. 10b constitutes a photograph from STEM of (W_{2/3}Sc_{1/3})₂AlC

FIG. 11a illustrate XRD spectra for (Mo_{2/3}Sc_{1/3})₂AlC powder

FIG. 11b constitutes a photograph from STEM of (Mo_{2/3}Sc_{1/3})₂AlC

FIG. 12a illustrate XRD spectra for (Mo_{2/3}Ho_{1/3})₂AlC powder

FIG. 12b constitutes a photograph from STEM of (Mo_{2/3}Ho_{1/3})₂AlC

FIG. 13a illustrate XRD spectra for (Mo_{2/3}Er_{1/3})₂AlC powder

FIG. 13b constitutes a photograph from STEM of (Mo_{2/3}Er_{1/3})₂AlC

FIG. 14a illustrate XRD spectra for (Mo_{2/3}Ce_{1/3})₂AlC powder

FIG. 14b constitutes a photograph from STEM of (Mo_{2/3}Ce_{1/3})₂AlC

FIG. 15a illustrate XRD spectra for (W_{2/3}Y_{1/3})₂AlC powder

FIG. 15b constitutes a photograph from STEM of (W_{2/3}Y_{1/3})₂AlC

FIG. 16a illustrate XRD spectra for (Sc_{0.60}Mo_{0.40})₂AlC, (Sc_{0.5}M_{0.5})₂AlC and (Mo_{0.67}Sc₀₃₃)₂AlC

FIG. 16b illustrates a photograph from STEM analysis of (Sc_{0.5}Mo_{0.5})₂AlC

FIG. 17a illustrates a STEM photograph of a side view of a previously known nanolaminated material with traditional structure, the nanolaminated material constituting Mn₂GaC

FIG. 17b illustrates a STEM photograph of a side view of the nanolaminated material (Mo_{2/3}Sc_{1/3})₂AlC

FIG. 17c illustrates STEM photographs of a top view of a substantially two-dimensional material obtained from the nanolaminated material (Mo_{2/3}Sc_{1/3})₂AlC of FIG. 17b

FIG. 17d illustrates a STEM photograph of a side view of a material obtained from the nanolaminated material (W_{2/3}Sc_{1/3})₂AlC after etching

FIG. 17e illustrates STEM photographs of a top view of a substantially two-dimensional material obtained from the nanolaminated material (Mo_{2/3}Y_{1/3})₂AlC at three different regions (I), (II) and (Ill).

FIG. 17f illustrate XRD spectra of (V_{2/3}Sc_{1/3})₂AlC and its resulting substantially two-dimensional material after etching.

FIG. 18 illustrates the test results from a capacitance test of (Mo_{2/3}η_{1/3})₂C, wherein η constitutes a vacancy, compared to the previously known Mo₂C

### DEFINITIONS

A two-dimensional material constitutes a material consisting of a single layer of atoms or crystal cells, and is sometimes referred to as a “single layer material”. Thus, in a two dimensional material, the atoms or, where applicable, crystal cells are repeated in two dimensions (x and y direction) but not in the third dimension (z direction), in contrast to a three-dimensional material where the atoms/crystal cells are repeated in all directions. However, as well known to the skilled person, no material constitutes a perfectly two-dimensional material since there will always be normally occurring defects present. Therefore, in the present disclosure, the term “substantially two-dimensional material” is used, which shall be considered to encompass both a perfect two-dimensional material as well as a two-dimensional material comprising normally occurring defects. Furthermore, a two-dimensional material or a substantially two-dimensional material shall not be considered to necessarily be flat but may for example also have a singled-curved, double-curved, undulating, rolled-up, or tube shape without departing from the scope of the present invention.

For the same reasons as explained above, the term “substantially two-dimensional array of crystal cells” is used in the present disclosure for defining an array of crystal cells in two dimensions (in contrast to three dimensions) taking into account that in reality crystal cells will most likely not be solely arranged in only two dimensions due to normally occurring defects.

Moreover, in view of the fact that the atoms (and/or vacancies) will most likely not be arranged in a perfectly octahedral array in view of the different atomic radii and possible normally occurring defects, the term “essentially octahedral array” is used herein. “Essentially octahedral array” shall thus be considered to encompass a perfect octahedral array as well as a slightly distorted octahedral array as will occur as a result of normally occurring defects and/or different atomic radii of the atoms (or a centre of a vacancy resulting from the removal of an atom).

### DETAILED DESCRIPTION

The invention will be described in more detail below with reference to the accompanying drawings, and certain embodiments. The invention is however not limited to the embodiments discussed but may be varied within the scope of the appended claims. Furthermore, the drawings shall not be considered drawn to scale as some features may be exaggerated in order to more clearly illustrate the invention.

The present inventors have discovered new three-dimensional nanolaminated materials, more specifically new quaternary MAX phase alloys from the 211 class of MAX phases, which provide chemical in-plane order. The quaternary MAX phase alloys comprises two transition metals, hereinafter denominated M1 and M2, in specific amounts. The MAX phase alloys provide chemical in-plane order since the M1 and M2 atoms of the newly identified MAX phase alloys are not randomly distributed within the M-layers of the MAX phase, but are arranged in a particular order.

The fact that the M1 and M2 atoms are ordered provides new possibilities for application of MAX phases, for example when synthesizing MXenes from such a MAX phases.

Tailoring MAX phase properties and realizing novel MXenes requires novel MAX phases. A density Functional Theory (DFT) formulation for predicting new stable phases within higher order materials systems has been developed, see M. Dahlqvist et al., Phys. Rev. B 81, 024111 (2010), Phys. Rev. B 81, 220102(R) (2010). Using DFT calculations and the simplex-optimization scheme, the relative stability of any hypothetical compound may be calculated relative to an identified set of stable competing phases. By this approach, numerous new MAX phases have been realized, see P. Eklund et al, Phys. Rev. Lett. 109, 035502 (2012) and A. S. Ingason et al, Phys. Rev. Lett. 110, 195502 (2013). The results reported indicate that MAX phase formation is mainly governed by the enthalpy term in the Gibbs free energy. However, for borderline cases, entropy and vibrational effects may come into play at higher temperatures.

The new nanolaminated materials have been identified through theoretical simulations as discussed above to primarily determine if the nanolaminated materials can be expected to be stable. Prediction of chemically ordered MAX phase alloys is based on evaluation of formation enthalpy of chemically ordered as well as disordered alloy configurations. If the ordered configuration is found to be more stable than the disordered one, then the chemically ordered material is suggested to be possible to synthesize. For borderline cases, the temperature at which entropy favors chemical disorder can be estimated along the lines as disclosed in Dahlqvist et al, Phys. Chem. Chem. Phys., 2015, 17, 31810-31821.

The theoretical simulations have furthermore been experimentally verified, as shown for example in the Experimental results given below.

The theoretical simulations have indicated that it is possible to add one transition metal selected from the group consisting of Hafnium (Hf), Scandium (Sc), Yttrium (Y) and Zirconium (Zr) into several 211 MAX phases wherein A is Aluminium (Al), X is Carbon (C) and M is selected from the group consisting of Chromium (Cr), Molybdenum (Mo), Niobium (Nb), Tantalum (Ta), Titanium (Ti), Vanadium (V) and Tungsten (W). In view of difficulties to theoretically simulate, it has further been assumed that similar results may be achieved by alternatively adding one of Cerium (Ce), Erbium (Er) and Holmium (Ho) into the several 211 MAX disclosed above (said assumption also experimentally verified as shown for example in the Experimental results given below). Thereby, MAX phases with the formula (M1_{x±β},M2_{y±ε})_{2-δ}Al_{1-α}C_{1±ρ}, wherein M1 and M2 each are selected from a first group of transition metals or a second group of transition metals, but M1 is selected from a different of said first group of transition metals and said second group of transition metals than M2, and wherein the sum of x and y is 1, are obtained. The first group of transition metals consists of Cr, Mo, Nb, Ta, Ti, V and W. The second group of transition metals consists of Ce, Er, Hf, Ho, Sc, Y and Zr. The theoretical simulations have furthermore demonstrated certain possible quaternary 211 MAX phases, wherein M1 and M2 both are selected from the first group of transition metals. These new MAX phases obtained through alloying with a second transition metal may in many cases be used for synthesis of substantially two-dimensional materials, i.e. MXenes, with specific properties depending on the M1 and M2 selected.

According to a first aspect of the present invention, M1 is selected from the first group of transition metals, and M2 is selected from the second group of transition metals.

According to a second aspect of the present invention, M1 is Ti and M2 is selected from the group consisting of Nb, Ta, V and W.

According to a third aspect of the present invention, M1 is Sc and M2 is either Mo or W.

According to a fourth aspect of the present invention M1 is Cr and M2 is Ta.

According to a fifth aspect of the present invention, M1 is selected from the group consisting of Cr, Nb, Ta and V, and M1 is Ti.

Moreover, it has been found that the relative amounts of two different transition metals in the nanolaminated material cannot be arbitrarily selected, but must be selected appropriately in order to enable a formation of a stable MAX phase (in the case of the alternatives of M1 and M2 available for the nanolaminated material according to the present invention), as well as the chemical ordering within the M-plane described below. In general, the amount of M1 should be essentially twice the amount of M2. Thus, in the nanolaminated material according to the present invention, x is between 0.60 and 0.75 and the sum of x and y is 1.00. Preferably, x is between 0.65 and 0.69. More preferably, x is 0.67, or more accurately x is preferably 2/3. For some particular combinations of transition metals, in a nanolaminated material according to the present invention, the transition metals in the above given formula may be interchanged. These combinations of transition metals in the nanolaminated material include the combinations Ti—Ta, Ti—Nb, Ti—V, Mo—Sc, and W—Sc.

It has further been found that in the resulting crystal cells of the nanolaminated material, i.e. the MAX phase, the M1 or M2 having the greatest atomic radius of M1 and M2 in most cases extend somewhat out of the M-plane towards the A-plane of the MAX phase alloy. Furthermore in the resulting crystal cells of the nanolaminated material, the M1 and M2 atoms are ordered, in contrast to randomly distributed, in relation to each other within the M-plane of the MAX phase. The reason is currently not fully understood since even though it is easy to understand that some modification of a the conventional crystal cell can be expected due to the difference in atomic radius between different M elements, an arbitrary selection of M1 and M2 may not necessarily have the same result and the chemical in-plane order may not always be achieved.

The possible selections of M1 and M2 elements in the formula (M1_{x±β},M2_{y±ε})_{2-δ}Al_{1-α}C_{1±ρ} of the nanolaminated material in accordance with the present invention is illustrated in Table 1 below, wherein the possible selections are marked with an X.

TABLE 1

| Transition | | M1 | | | | | | | |
|---|---|---|---|---|---|---|---|---|---|
| metal | | Cr | Mo | Nb | Ta | Ti | V | W | Sc |
| M2 | Cr | | | | | | | | |
| | Mo | | | | | | | | X |
| | Nb | | | | | X | | | |
| | Ta | X | | | | X | | | |
| | Ti | X | | X | X | | X | | |
| | V | | | | | X | | | |
| | W | | | | | X | | | X |
| | Ce | X | X | X | X | X | X | X | |
| | Er | X | X | X | X | X | X | X | |
| | Hf | X | X | X | X | X | X | X | |
| | Ho | X | X | X | X | X | X | X | |
| | Sc | X | X | X | X | X | X | X | |
| | Y | X | X | X | X | X | X | X | |
| | Zr | X | X | X | X | X | X | X | |

Furthermore, it has been found that for the specific embodiments wherein M1 is Cr, the relative amounts of M1 and M2 is very important in order to achieve chemical in-plane ordering. Previously known MAX-phases comprising two transition metals in equal amounts, and wherein one of the transition metals is Cr have shown a random distribution of the transition metals within the M-plane. Thus, the combinations wherein M1 is Cr these tend to be more sensitive to variations in the relative amount between Cr and M2 in order to achieve chemical ordering in the M-plane of the nanolaminated material. Therefore, in case M1 is Cr, x should preferably be ⅔. According to an alternative embodiment of the present invention, the possibilities shown in Table 1 wherein M1 is Cr may be excluded for the same reason.

Moreover, it has been found that certain embodiments of the nanolaminated material may be difficult to produce in accordance with a conventional bulk synthesis merely comprising mixing powders and heating the powders to a temperature in the range of about 1400° C. to about 1600° C. in for example an argon atmosphere. Examples of nanolaminated materials which in some cases may be difficult to produce according to such a process include (Ti_{2/3}Y_{1/3})₂AlC and (Cr_{2/3}Zr_{1/3})₂AlC. Thus, in view of the fact that it is desirable to be able to easily produce the nanolaminated material without use of for example pressurised or reactive sintering, or other modifications of the parameters of the synthesis such as higher synthesis temperature and/or quenching after synthesis, these examples of nanolaminated materials may according to one embodiment of the present invention be excluded.

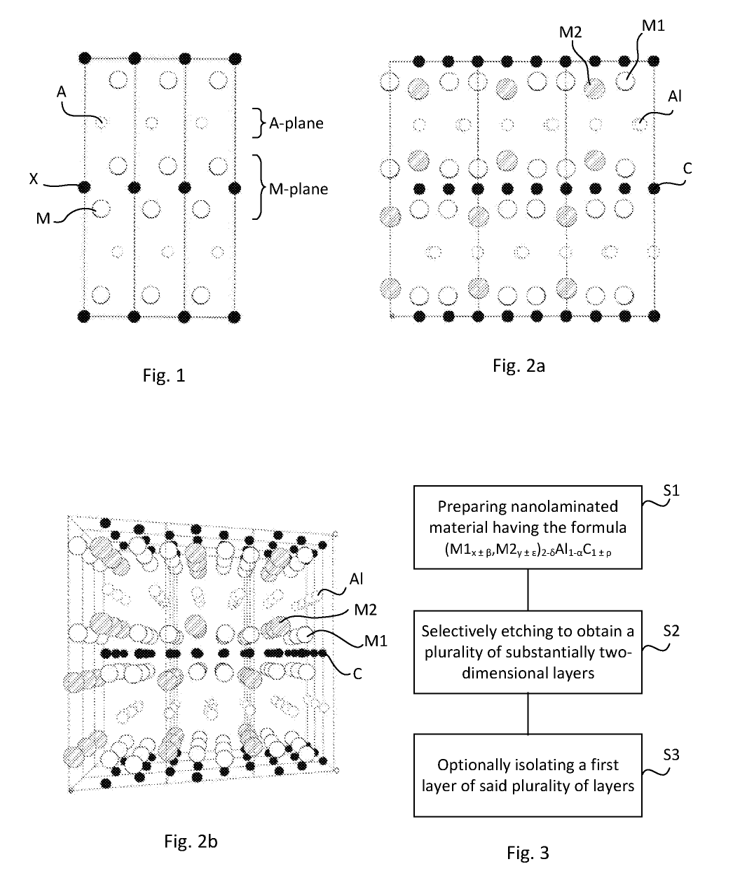

Conventional MAX phases typically comprise three elements, M, A and X, forming for example M₂AX in the case of 211 MAX phase. FIG. 1 illustrates a side view of the atomic structure of a conventional 211 MAX phase. As can be seen from FIG. 1, near-closed packed payers of the M-element are interleaved with pure A-group element layers, with the X atoms filling the octahedral sites between the former.

In contrast to the conventional MAX phase described above and shown in FIG. 1, the new MAX phases found by the present inventors originate from alloying with a second M element, to realise quaternary alloys where there is chemical ordering in the M-plane as disclosed above. The resulting nanolaminated material has thus the general formula (M1ₓ,M2_{y})₂AlC, wherein the sum of x and y is 1, and x is from 0.60 to 0.75 (including the end values). However, in reality the (M1ₓ,M2_{y})₂AlC formula may invite to a too strict interpretation inter alia since there are always normally occurring defects in a material, such as unintended and randomly distributed vacancies. Furthermore, the composition of the nanolaminated material may diverge from the exact (M1ₓ,M2_{y})₂AlC formula for example due to partial sublimation of Al, and/or possible uptake of carbon from a graphite crucible and/or die, if such are used, during synthesis. There is also a risk for loss of carbon during synthesis in many cases. Therefore, a more accurate formula for the nanolaminated material is (M1_{x±β},M2_{y±ε})_{2-δ}Al_{1-α}C_{1±ρ}, wherein β, ε, δ, α and ρ takes into account expected possible divergence from a true (M1ₓ,M2_{y})₂AlC composition. Each of β and ϵ may be from 0 to ≤0.10, preferably from 0 to ≤0.05. Each of δ, α and ρ may be from 0 to ≤0.20, preferably from 0 to ≤0.10.

An alternative way of expressing the present invention is a nanolaminated material having the composition (M1ₓ,M2_{y})₂AlC but comprising normally occurring defects, and wherein the sum of x and y is 1, and M1 and M2 each are selected as disclosed above.

However, for the purpose of facilitating the reading of the present disclosure, the actual formula (M1_{x±β},M2_{y±ε})_{2-δ}Al_{1-α}C_{1±ρ} of the nanolaminated material according to the present invention will be simplified in the following by using the general formula (M1ₓ,M2_{y})₂AlC. Thus, whenever the general formula (M1ₓ,M2_{y})₂AlC is used in the following disclosure, it shall be considered to in fact constitute the formula (M1_{x±β},M2_{y±ε})_{2-δ}Al_{1-α}C_{1±ρ}. This is also the case when specific elements of M1 and M2 are given in the formula and/or where specific figures are given for x and/or y in the formula, unless explicitly disclosed otherwise. By way of example, “(Mo_{0.67}Y_{0.33})₂AlC” shall in fact be interpreted as (Mo_{0.67}±Y_{0.33±ε})_{2-δ}Al_{1-α}C_{1±ρ}; “(V_{0.67}Zr_{0.33})₂AlC” shall in fact be interpreted as (Vo_{0.67±β}Zr_{0.33±ε})_{2-δ}Al_{1-α}C_{1±ρ}; and “(Sc_{0.67}W_{0.33})₂AlC” shall in fact be interpreted as (Sc_{0.67±β}W_{0.33±ε})_{2-δ}Al_{1-α}C_{1±ρ}.

FIG. 2a schematically illustrates a side view and FIG. 2b schematically illustrates a perspective view of a nanolaminated material according to one exemplifying embodiment of the present invention. The nanolaminated material comprises a first transition metal M1 and a second transition metal M2, as well as aluminium Al and carbon C. In the exemplifying embodiment shown in FIGS. 2a and 2b, x would be ⅔ and y would be ⅓. In other words, the amount of M1 atoms is twice the amount of M2 atoms. The nanolaminated material according to this exemplifying embodiment thus has the general formula (M1_{2/3},M2_{1/3})₂AlC. Furthermore, in the exemplifying embodiment, M1 may suitably be selected from a first group of transition metals consisting of Cr, Mo, Nb, Ta, Ti, V and W, and M2 may suitably be selected from a second group of transition metals consisting of Ce, Er, Hf, Ho, Sc, Y and Zr. Thereby, the atomic radius of the M2 atoms is greater than the atomic radius of the M1 atoms. As can be seen from the figures, the M1 and M2 atoms are chemically ordered in relation to each other and the M2 atoms extend out of the M1-plane towards the A-plane formed by the Al atoms. The C atoms are positioned within octahedral arrays formed by the M1 and M2 atoms.

The present invention further relates to a process for manufacturing a material comprising at least one layer constituting a substantially two-dimensional array of crystal cells. This process may result in a stacked assembly comprising a plurality of individual layers each constituting a substantially two-dimensional array of crystal cells, or alternatively in one or more separated and isolated layers each constituting a substantially two-dimensional array of crystal cells. In other words, the present invention further provides a process for synthesis of new MXenes.

FIG. 3 schematically illustrates a process for manufacturing a material comprising at least one layer constituting a substantially two-dimensional array of crystal cells. The process comprises a first step, S1, comprising preparing a nanolaminated material having the formula (M1_{x±β},M2_{y±ε})_{2-δ}Al_{1-α}C_{1±ρ}. M1 is a first transition metal and M2 is a second transition metal. The sum of x and y in the formula is 1, and x is between 0.60 and 0.75. Preferably, x is between 0.65 and 0.69. More preferably, x is 0.67, or more accurately x is preferably 2/3. According to one embodiment, M1 may suitably be selected from a first group of transition metals consisting of Cr, Mo, Nb, Ta, Ti, V and W, and M2 may suitably be selected from a second group of transition metals consisting of Ce, Er, Hf, Ho, Sc, Y and Zr. According to another embodiment, M1 is Ti and M2 is selected from the group consisting of Nb, Ta, V and W. According to yet an embodiment, M1 is Cr and M2 is Ta (for which case x is preferably 2/3). According to yet an embodiment, M1 is selected from the group consisting of Cr, Nb, Ta and V, and M2 is Ti.

The nanolaminated material may be prepared according to conventional methods for producing MAX materials as known in the art. Preferably, the nanolaminated material is produced by a bulk method for sake of simplicity, however other processes, such as chemical vapour deposition (CVD) or physical vapour deposition (PVD), are also possible. The nanolaminated material may according to a preferred embodiment for example be produced by mixing powders of the elements in the stoichiometric amounts of the intended nanolaminated material and heating the mixture to an appropriate temperature under argon atmosphere.

The nanolaminated material is in a second step, S2, selectively etched so as to remove substantially all of the Al atoms thereby obtaining a plurality of substantially two-dimensional layers. Each substantially two-dimensional layer constitutes a substantially two-dimensional array of crystal cells. Depending on the M1 and M2 of the nanolaminated material as well as the etching solution used, the M2 atoms may optionally also be selectively etched. Etching of the M2 atoms may be conducted either simultaneously with the Al atoms or in a separate etching step. The resulting substantially two-dimensional layers thus each have an empirical formula (M1_{x±β},η_{y±ε})_{2-δ}C_{1±ρ} wherein η is either M2 or a vacancy.

Etching may suitably be made using an etching solution comprising hydrogen fluoride (HF), hydrogen fluoride (HF) and hydrochloric acid (HCl), ammonium bifluoride (NH₄HF₂), lithium fluoride (LiF), or lithium fluoride (LiF) and hydrochloric acid (HCl). It has been found that the presence of HCl in the etching solution may in some cases facilitate the delamination of the individual substantially two-dimensional layers of the nanolaminated material.

It will be readily understood by the skilled person that each substantially two-dimensional layer further comprises a surface termination Tₛ resulting from the etching. The surface termination constitutes a functional group and depends on the etching solution used. The surface termination may for example be —O, —H, —OH or —F, or any combination thereof, in the case of etching is performed using an etching solution comprising HF. Other surface terminations are however also plausible depending on the etching solution used. It should furthermore be noted that the surface termination may be altered after etching, in accordance with any previously known method, without departing from the scope of the present invention. For example, the surface termination may be altered during an optional intercalation step and/or an optional subsequent washing step used for isolating the individual substantially two-dimensional layers.

The method may optionally also comprise an intercalation step subsequent to the etching step, but before the optional step of isolating one or more of the substantially two-dimensional layers as disclosed below. An intercalation step may for example be beneficial in case of using an etching solution comprising HF.

The method may further comprise one or more washing steps as known in the art. Such washing steps depend for example on the etching solution used and/or the desired surface termination of the individual two-dimensional layers. For example, in case the etching solution comprises LiF and HCl, washing may suitably be made in three steps wherein in the first washing step HCl may be used, in the second washing step LiCl solution may be used and in the third washing step water may be used used.

The resulting plurality of substantially two-dimensional layers may be used as a stacked assembly (in the as-etched form) for the intended application of the material comprising a plurality of layers each constituting a substantially two-dimensional array of crystal cells. Alternatively, the process may further comprise a third step, S3, comprising isolating a first layer of said plurality of substantially two-dimensional layers. In the step of isolating the first layer out of said plurality of substantially two-dimensional layers, the as-etched stacked assembly is delaminated.

The process as disclosed above results either in a plurality of substantially two-dimensional layers in an as-obtained stacked assembly (as-etched stacked assembly) or as one or more isolated layer(s) of said plurality of substantially two-dimensional layers. In the case of the M2 atoms being etched out of the nanolaminated material, the resulting two-dimensional layers (or the isolated layers) will comprise ordered vacancies. This is a direct consequence of the fact that in the nanolaminated material the M1 and M2 atoms are chemically ordered within the M-plane.

In order to be able to easily selectively etch M2 atoms, while maintaining the M1 atoms in the crystal cells, it is currently believed that the M2 atoms should have a greater atomic radius than the M1 atoms and preferably also extend somewhat out of the M-plane of the nanolaminated material. However, not all possible combinations where the M2 atoms have a greater atomic radius than M1 in the nanolaminated material are believed to enable etching of the M2 atoms. Examples where M2 atoms may be selectively etched include M1 and M2 combinations of the nanolaminated material where M2 is Sc or Y.

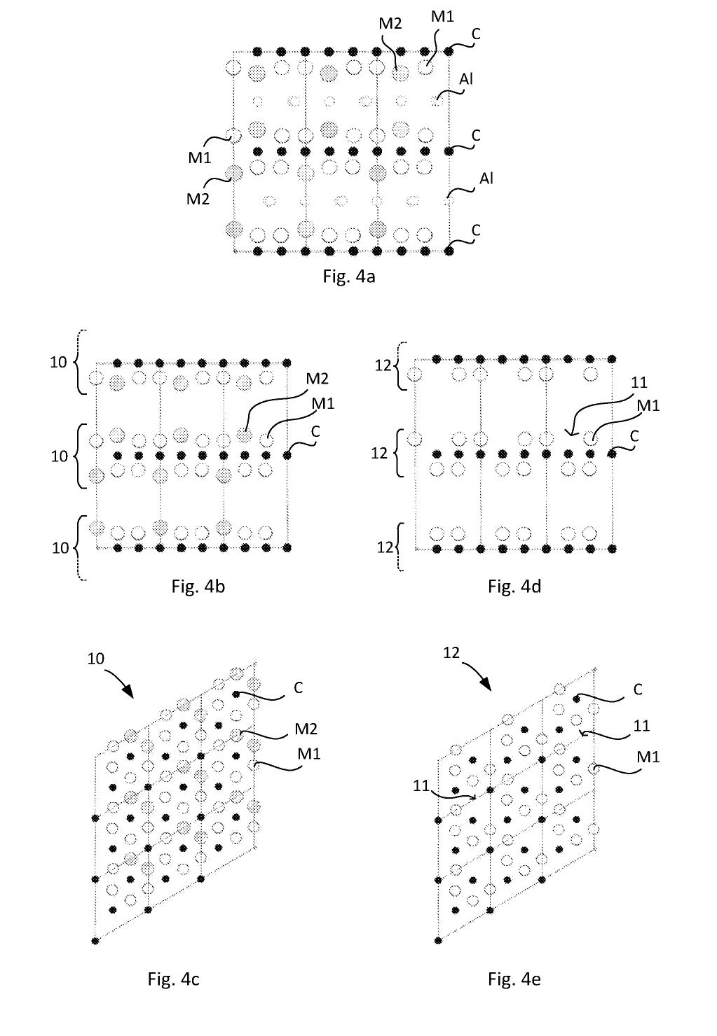

The process is further illustrated with reference to FIGS. 4a to 4e. FIG. 4a schematically illustrates a side view of a nanolaminated material in accordance with the exemplifying embodiment discussed with reference to FIGS. 2a and 2b, FIG. 4a thus corresponds to FIG. 2a.

FIG. 4b schematically illustrates a stacked assembly obtained through etching of the nanolaminated material as illustrated in FIG. 4a so as to remove essentially all of the Al atoms, i.e. the A-layer of the nanolaminated material. In the stacked assembly as illustrated in FIG. 4b, the M2 atoms have not been etched away. The stacked assembly thus comprises a plurality of substantially two-dimensional layers 10 (only one completely shown in the figure) each having an empirical formula (M1_{x±β},M2_{y±ε})_{2-δ}C_{1±ρ} and comprising a surface termination Ts (not illustrated) as disclosed above. Depending on the etching solution used, the individual two-dimensional layers 10 can be separated and isolated from one another in the etching solution or in a separate delamination step. FIG. 4c schematically illustrates a top view of an isolated substantially two-dimensional layer 10. As can be seen from FIGS. 4b and 4c, the M1 and M2 atoms are chemically ordered in relation to each other, i.e. not randomly distributed in the M sites of the crystal cells.

FIG. 4d schematically illustrates a stacked assembly obtained through etching of the nanolaminated material as illustrated in FIG. 4a so as to remove essentially all of the Al atoms as well as the M2 atoms. In the resulting substantially two-dimensional layers, the sites where M2 were present in the crystal cells of the nanolaminated material will thus result in a vacancy 11. The stacked assembly thus comprises a plurality of substantially two-dimensional layers 12 (only one completely shown in the figure) each having an empirical formula (M1_{x±β},η_{y±ε})_{2-δ}C_{1±ρ} wherein η is a vacancy. Each substantially two-dimensional layer also comprises a surface termination Ts (not illustrated) as disclosed above. The individual two-dimensional layers 12 can be separated and isolated from each other as previously disclosed. FIG. 4e schematically illustrates a top view of an isolated substantially two-dimensional layer 12. As can be seen from FIG. 4e, the two-dimensional layer comprises ordered vacancies 11.

The present invention also relates to a substantially two-dimensional material which may be obtained through the process as disclosed above. In contrast to previously known MXenes, the substantially two-dimensional layer according to the present invention provides chemical ordering of two different transition metals, or comprises only one transition metal and furthermore ordered vacancies at M-sites of the substantially two-dimensional material.

The resulting two-dimensional material according to the present invention comprises a layer having the general formula (M1,η_{y})₂C wherein η is either M2 or a vacancy, the sum of x and y is 1.00, and x is between 0.60 and 0.75. Preferably, x is between 0.65 and 0.69. More preferably, x is 0.67, or more accurately x is preferably 2/3. M1 is selected from a first group of transition metals consisting of Cr, Mo, Nb, Ta, Ti, V and W. Furthermore, when η is M2, M2 is selected from a second group of transition metals consisting of Er, Hf, Ho, Sc, Y and Zr.

However, in reality the (M1,η_{y})₂C formula may invite to a too strict interpretation inter alia since there are always normally occurring defects in a material. Furthermore, in view of the fact that the composition of the nanolaminated material from which the two-dimensional material is synthesized may diverge from the exact (M1ₓ,M2_{y})₂AlC formula as discussed above, the corresponding difference will also be present in the substantially two-dimensional material. Therefore, a more accurate formula for the layer of the substantially two-dimensional material is (M1_{x±β},η_{y±ε})_{2-δ}C_{1±ρ} wherein β, ε, δ, and ρ takes into account expected possible divergence from a true (M1ₓ,η_{y})₂C formula. Each of β and ε may be from 0 to ≤0.10, preferably from 0 to ≤0.05. Each of δ, and ρ may be from 0 to ≤0.20, preferably from 0 to ≤0.10.

However, for the purpose of facilitating the reading of the present disclosure, the actual formula (M1_{x±β},η_{y±ε})_{2-δ}C_{1±ρ} of the layer of the substantially two-dimensional material according to the present invention will be simplified in the following by using the general formula (M1ₓ,η_{y})₂C. Thus, whenever the general formula (M1ₓ,η_{y})₂C is used in the following disclosure, it shall be considered to in fact constitute the formula (M1_{x±β},η_{y±ε})_{2-δ}C_{1±ρ}. This is also the case when specific elements of M1 and possibly M2 are given in the formula and/or where specific figures are given for x and/or y in the formula. By way of example, “(Mo_{0.67}η_{0.33})₂C” shall in fact be interpreted as (Mo_{0.67±β}η_{0.33±ε})_{2-δ}C_{1±ρ}; and “(W_{0.67}η_{0.33})₂C” shall in fact be interpreted as (W_{0.67±β}η_{0.33±ε})_{2-δ}C_{1±ρ}.

In accordance with the first aspect of the present invention, in the nanolaminated material M1 may be selected from the first group of transition metals and M2 may be selected from the second group of transition metals. The first group of transition metals (as defined above) comprises transition metals which generally have a smaller atomic radius than the transition metals of the second group of transition metals. According to other aspects of the present invention, in the nanolaminated material, M1 and M2 are both selected from the first group of transition metals as disclosed above and constitute specific combinations. In view of the fact that the transition metal of the nanolaminated material which has the greatest atomic radius will extend out of the M-plane towards the A-plane and therefore will be more easily etched (also depending on the transition metal and on the etching solution used) when synthesising the substantially two-dimensional material, it may be difficult to synthesize a substantially two-dimensional material from all of the nanolaminated materials of the present invention merely using the etching solution and processes which are currently used in the art. Moreover, the substantially two-dimensional material must comprise a sufficient amount of transition metals in order to be sufficiently mechanically stable and not break, and therefore the M1 atoms must remain after etching since the amount of M1 atoms is greater than the M2 atoms. Therefore, it is currently believed that it is only possible to synthesise a substantially two-dimensional material out of the nanolaminated materials wherein either:
M1 is selected from the group consisting of Cr, Mo, Nb, Ta, Ti, V and W, and M2 is selected from the group consisting of Ce, Er, Hf, Ho, Sc, Y and Zr; or
M1 is Ti, and M2 is selected from the group consisting of Nb, Ta, V, and W; or
M1 is Cr and M2 is Ta; or
M1 is selected from the group consisting of Cr, Nb, Ta and V, and M2 is Ti.

According to a preferred embodiment, the nanolaminated material according to the present invention is selected from the group consisting of:
(Mo_{x±β},Y_{y±ε})_{2-δ}Al_{1-α}C_{1±ρ};
(V_{x±β},Zr_{y±ε})_{2-δ}Al_{1-α}C_{1±ρ};
(Cr_{x±β},Sc_{y±ε})_{2-δ}Al_{1-α}C_{1±ρ};
(Cr_{x±β},Y_{y±ε})_{2-δ}Al_{1-α}C_{1±ρ};
(V_{x±β},Sc_{y±ε})_{2-δ}Al_{1-α}C_{1±ρ};
(W_{x±β},Sc_{y±ε})_{2-δ}Al_{1-α}C_{1±ρ};
(Mo_{x±β},Sc_{y±ε})_{2-δ}Al_{1-α}C_{1±ρ};
(Mo_{x±β},Ho_{y±ε})_{2-δ}Al_{1-α}C_{1±ρ};
(Mo_{x±β},Er_{y±ε})_{2-δ}Al_{1-α}C_{1±ρ};
(Mo_{x±β},Ce_{y±ε})_{2-δ}Al_{1-α}C_{1±ρ}; and
(W_{x±β},Y_{y±ε})_{2-δ}Al_{1-α}C_{1±ρ}.

According to another preferred embodiment, the layer of the substantially two-dimensional material according to the present invention has a formula selected from the group consisting of:
(Mo_{x±β},η_{y±ε})_{2-δ}C_{1±ρ} wherein η is a vacancy or Y;
(W_{x±β},η_{y±ε})_{2-δ}C_{1±ρ} wherein η is a vacancy; and
(V_{x±β},η_{y±ε})_{2-δ}C_{1±ρ} wherein η is a vacancy.

Potential areas of application of MAX phases in general are given in the background portion of the present disclosure. The potential areas of the MAX phase alloys according to the present invention, i.e. the nanolaminated material according to the present invention, include, but are not limited to, all these applications. The MAX phase alloys according to the present invention increase the family of to date known MAX phase elements with Y, W, Ho, Er, and Ce, and therefore novel properties are expected. The rich chemistries of the enlarged family of MAX phases also suggest routes for property tuning by varying the composition.

Potential applications for MXenes in general include sensors, electronic device materials, catalysts in the chemical industry, conductive reinforcement additives to polymers, electrochemical energy storage materials, etc. The potential areas of the herein presented MXenes, i.e. the substantially two dimensional material, include, but are not limited to, all these applications. Furthermore, one can envisage that the obtained vacancy formation in the MXenes strongly influence the range of attainable properties, where the vacancy can serve as a site with increased reactivity, and as a site for dopants, allowing atoms/ions/molecules to be inserted as well as extracted, which in turn may be of importance for general property tuning, for filtering applications, biomedical applications, etc. The substantially two-dimensional material according to the present invention is believed to be especially suitable for use in energy storage devices, for example lithium-ion batteries.

### EXPERIMENTAL RESULTS

### Experimental Result 1—(Mo_{0.67}Y_{0.33})₂AlC

Commercially available powders were used for synthesis. The powders used were graphite (99.999%, −200 mesh, Alfar Asar), Mo (99.99%, 10 μm, Sigma-Aldrich), Y (99.5%, −40 mesh, Sigma-Aldrich) and Al (99.8%, −200 mesh, Sigma-Aldrich), wherein the figures in parentheses are representing the minimum purity of the powders and the particle size of the powders. To obtain the (Mo_{2/3}Y_{1/3})₂AlC powder sample, stoichiometric amounts were mixed in an agate mortar, heated to 1600° C. at 10° C./min in an alumina crucible under flowing argon and held at that temperature for 10 h. After cooled down to room temperature in the furnace, loosely packed powder was obtained. The loosely packed powder was crushed in the agate mortar into powder. The crushed powder was used for X-ray diffraction (XRD) and scanning transmission electron microscopy (STEM) analysis.

A powder sample was characterized by XRD (theta-2theta scan) at a continuous scanning mode. XRD patterns were recorded with a powder diffractometer (PANalytical X′Pert powder diffractometer) using CuK_{α} radiation (λ=1.54 Å) with 0.0084° steps of 2θ and with a dwelling time of 20 s.

Powder (from the same batch as the powder sample used for XRD) was used directly for STEM analysis and prepared in accordance with conventional processes. STEM analysis of the nanolaminated material was performed in a double-corrected FEI Titan3 60-300, operated at 200 kV. Powder was dispersed onto a standard holey amorphous carbon support films suspended by a Cu grid.

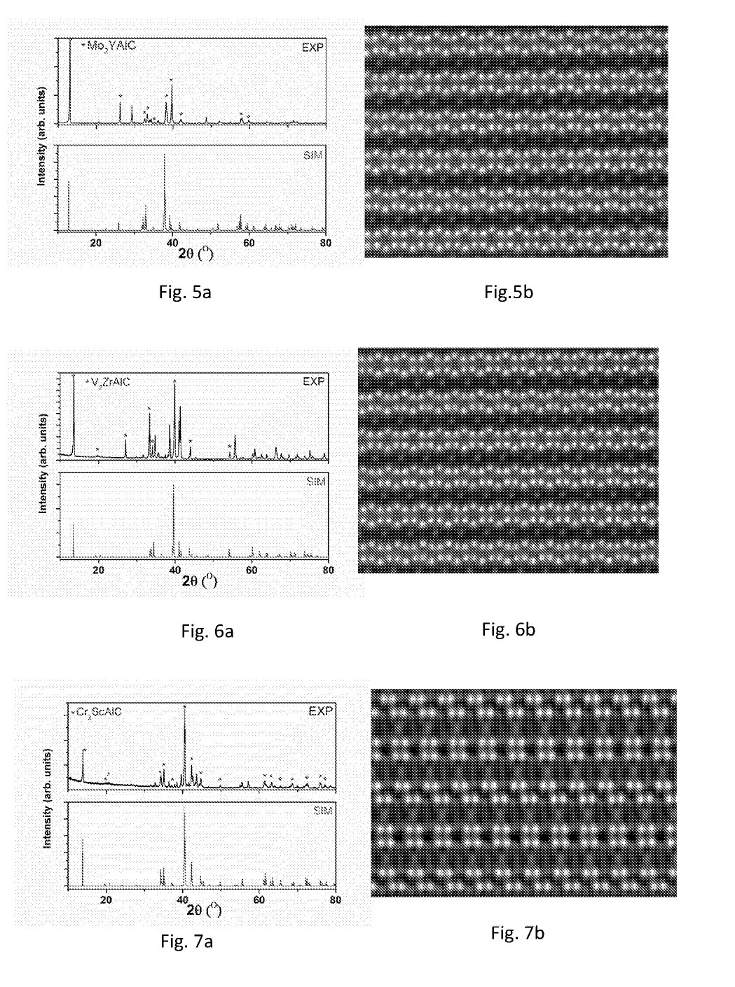

The result of the XRD analysis is shown in FIG. 5a, wherein the upper part illustrates the actually obtained spectrum and the lower part illustrates a simulated spectrum (simulated with Crystalmaker software, based on structure obtained from theoretical simulations). Major peaks marked with * correspond to the MAX phase, and corresponding peaks are also seen in the simulated spectra. The chemically ordered MAX phase alloys have to a large extent the same XRD spectra as traditional MAX phases (which can be found in reference databases of the diffractometer). Still, the chemical in-plane ordering give for most phases rise to an additional peak around 19 degrees, which has been used to identify new phases for further analysis with STEM.

FIG. 5b illustrates a photograph from STEM of a grain of the nanolaminated material (Mo_{2/3}Y_{1/3})₂AlC obtained. As can be seen from the figure, the Mo and Y atoms are chemically ordered in relation to each other and the Y atoms extend somewhat out of the M-plane towards the A-plane. In FIG. 5b, the respective layers of M-atoms are not identical. This is due to the fact that the layers are rotated in plane in relation to an adjacent M-plane.

### Experimental Result 2—(V_{0.67}Zr_{0.33})₂AlC

Commercially available powders were used for synthesis. The powders used were graphite (99.999%, −200 mesh), V (99.5%, −325 mesh), Zr (99%, −100 mesh) and Al (99.8%, −200 mesh), wherein the figures in parentheses representing the minimum purity of the powders and the particle size of the powders. All powders apart from the graphite powder were from Sigma-Aldrich. The graphite powder was from Alfar Asar. To obtain the (V_{2/3}Zr_{1/3})₂AlC powder sample, stoichiometric amounts were mixed in an agate mortar, heated to 1500° C. at 10° C./min in alumina crucible under flowing argon and held at that temperature for 2 h. After cooled down to room temperature in the furnace, loosely packed powder was obtained. The powder was crushed in the agate mortar into fine powder. Fine powder were used for X-ray diffraction (XRD) and scanning transmission electron microscopy (STEM) analysis in the same way as in Experimental result 1 given above.

Experimental procedure and evaluation of the results are in accordance with those for (Mo_{2/3}Y_{1/3})₂AlC above. The result of the XRD is shown in FIG. 6a. FIG. 6b illustrates a photograph from STEM. From the result it can be concluded that a MAX-phase has been obtained and that the V and Zr atoms are chemically ordered in relation to each other. It can further be seen that the Zr atoms extend somewhat out of the M-plane towards the A-plane.

### Experimental Result 3

Additional MAX-phases were synthesized according to essentially the same procedure as disclosed above with regard to Experimental results 1 and 2, with the only differences being the starting powders, the temperature during synthesis, and holding time. The materials and process details are given in Table 2 below. The Al and graphite powders used each have a particle size of −200 mesh (corresponding to 75 am). All powders except for the graphite powder were from Sigma-Aldrich. The graphite powder was from Alfar Asar.

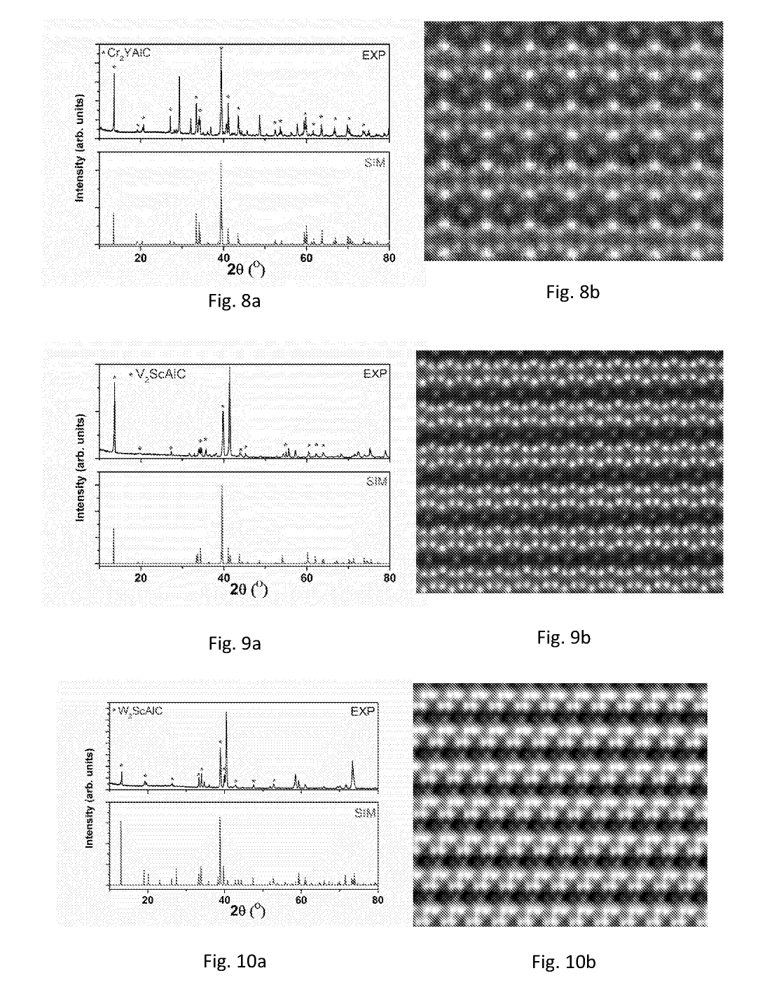

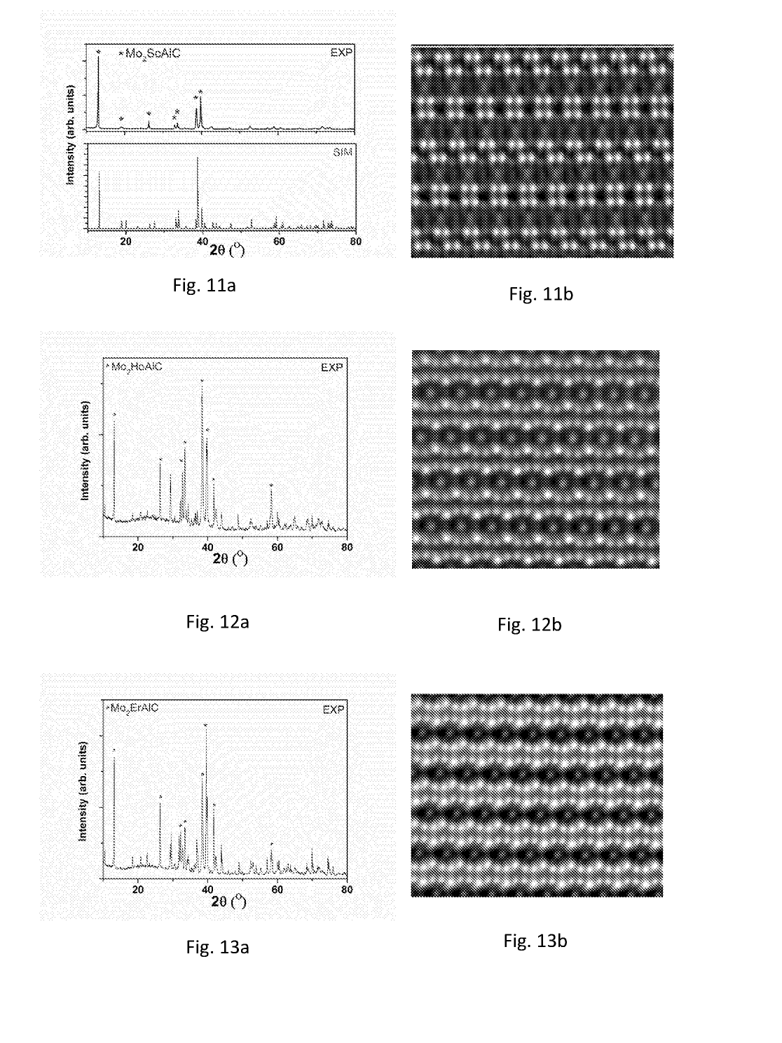

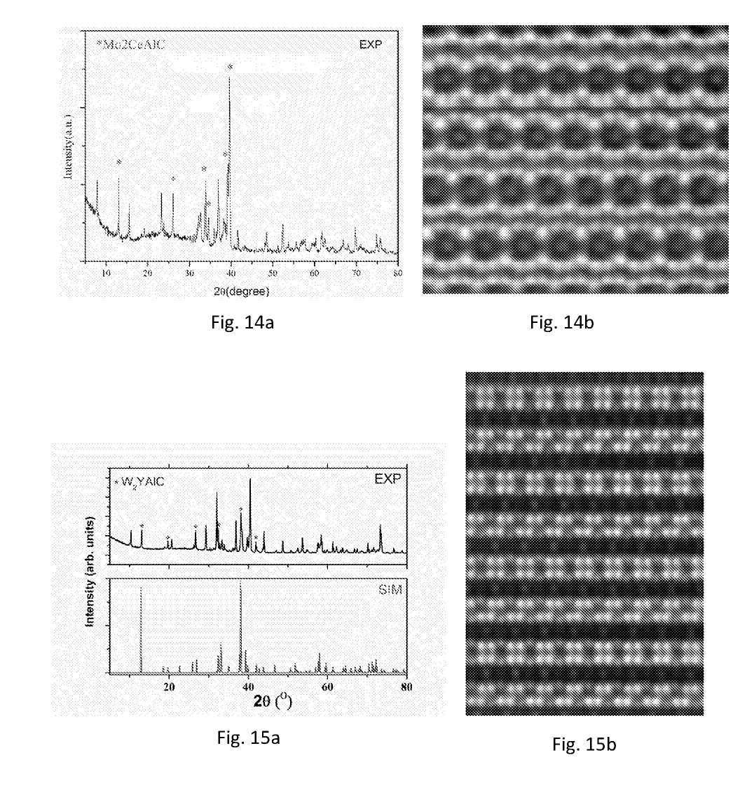

TABLE 2

| | | | Particle size of starting | |
|---|---|---|---|---|
| | | Holding | material | XRD and STEM, |
| | Temperature | time | (mesh, except where | respectively |
| Material | (° C.) | (min) | otherwise specified) | illustrated in figure |
| (Cr_{2/3}Sc_{1/3})₂AlC | 1400 | 120 | Cr: −100, Sc: −200 | FIGS. 7a and 7b |
| (Cr_{2/3}Y_{1/3})₂AlC | 1400 | 120 | Cr: −100, Y: −40 | FIGS. 8a and 8b |
| (V_{2/3}Sc_{1/3})₂AlC | 1400 | 300 | V: −325, Sc: −200 | FIGS. 9a and 9b |
| (W_{2/3}Sc_{1/3})₂AlC | 1500 | 120 | W: 12 μm, Sc: −200 | FIGS. 10a and 10b |
| (Mo_{2/3}Sc_{1/3})₂AlC | 1500 | 1200 | Mo: 10 μm, Sc: −200 | FIGS. 11a and 11b |
| (Mo_{2/3}Ho_{1/3})₂AlC | 1500 | 240 | Mo: 10 μm, Ho: 10 mm | FIGS. 12a and 12b |
| | | | chips | |
| (Mo_{2/3}Er_{1/3})₂AlC | 1500 | 240 | Mo: 10 μm, Er: 10 mm | FIGS. 13a and 13b |
| | | | chips | |
| (Mo_{2/3}Ce_{1/3})₂AlC | 1500 | 240 | Mo: 10 μm, Ce: 10 mm | FIGS. 14 a and 14b |
| | | | chips | |
| (W_{2/3}Y_{1/3})₂AlC | 1500 | 120 | W: 12 μm, Y: −40 | FIGS. 15a and 15b |

Experimental procedure and evaluation of the results of the nanolaminated materials are in accordance with those disclosed above for (Mo_{2/3}Y_{1/3})₂AlC under Experimental result 1.

It should be noted that the photographs from STEM may be taken at different magnitudes and the scale has not been given in the figures. The photographs should therefore in the present disclosure only be considered as far as to illustrate the observed ordering of the transition metals of the nanolaminated materials and how the atoms are arranged in relation to each other, such as one of the transition metals extending out of the M-plane.

Furthermore, the obtained STEM photographs for the different materials are obtained along different zone axis, which explains why stacking sequences of different materials may look different. The mass contrast between M1 and M2, and the choice of zone axis, decides how clearly the elements as well as their positions are visible. STEM analysis in FIG. 7b, FIG. 10b and FIG. 11b are obtained from grains having an orientation which is not optimal for visualisation, which is why the M2 elements are only vaguely visible in these photographs. However, it can still be seen that there is in-plane chemical ordering of the transition metals.

The above given results shown in the FIGS. 7a-15b demonstrate that MAX phases with in-plane chemical ordering of the transition metals were obtained for all of the synthesised nanolaminated materials as given in Table 2.

It can be seen from FIG. 15b, that the extension of Y atoms out of the M-plane is small in the case of the nanolaminated material (W_{2/3}Y_{1/3})₂AlC, but there is in-plane chemical ordering of the W and Y atoms.

### Experimental Result 4

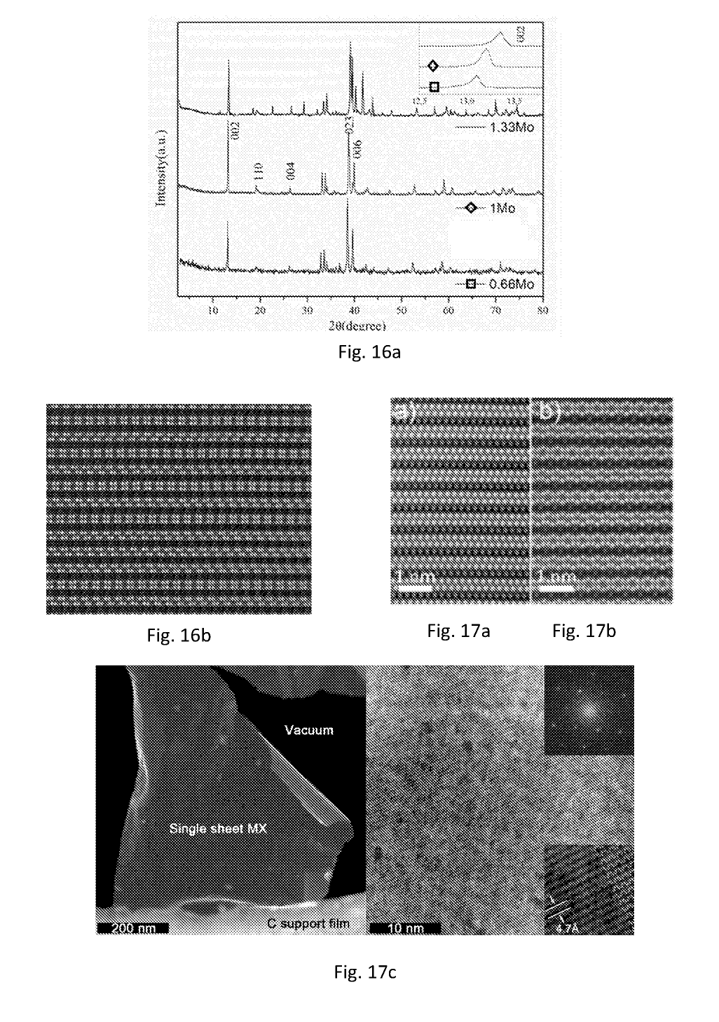

Experimental tests were performed to synthesize (Sc_{0.67}Mo_{0.33})₂AlC and (Sc_{0.50}Mo_{0.50})₂AlC, to be compared with previously synthesized (Mo_{0.67}Sc_{0.33})₂AlC as given above under Experimental results 3. This corresponds to Mo_{0.66}, Mo₁ and Mo_{1.33} per formula unit, and results from XRD as given in FIG. 16a show that MAX phase is found for all three samples, and that there is a peak shift towards lower angles with an increase in Sc content. Compositional analysis from EDX of MAX phase grains shows compositions corresponding to (Sc_{0.60}Mo_{0.40})₂AlC, (Sc_{0.5}M_{0.5})₂AlC, and (Mo_{0.67}Sc_{0.33})₂AlC. (The sample with highest Sc content diverges slightly from the initial powder ratio.) STEM analysis of (Sc_{0.5}Mo_{0.5})₂AlC shows a MAX phase with in-plane ordering. FIG. 16b illustrates a photograph from STEM analysis of the (Sc_{0.5}Mo_{0.5})₂AlC. STEM analysis of (Sc_{0.60}Mo_{0.40})₂AlC shows a similar structure.

### Experimental Result 5

Substantially two-dimensional materials were synthesised from the nanolaminated material according to Experimental result 1 and some of nanolaminated materials of Experimental result 3 as given in Table 2. The substantially two-dimensional materials where selectively etched using the etching conditions, intercalated in a separate step (in the case of the etching solution comprising HF) and washed as given in Table 3. Etching was performed at room temperature expect where specified. As can be seen from Table 3, for the nanolaminated materials etched with an etching solution comprising HF, tetrabutylammonium hydroxide (TBAOH) was used for intercalation.

TABLE 3

| | | | Separate | |
|---|---|---|---|---|
| Nanolaminated | Etching | Etching | intercalate | Washing |
| material | solution | time | step | step |
| (Mo_{2/3}Y_{1/3})₂AlC | HF 50% | 12 h | TBAOH | water |
| (V_{2/3}Sc_{1/3})₂AlC | HF 50% | 24 h | TBAOH | water |
| (W_{2/3}Sc_{1/3})₂AlC | HF 50% | 24 h (at 35° C.) | TBAOH | water |
| (Mo_{2/3}Sc_{1/3})₂AlC | HF | 24 h | TBAOH | water |
| (Mo_{2/3}Sc_{1/3})₂AlC | LiF + HCl | 72 h | — | water |

STEM analysis of the substantially two-dimensional materials was performed in a double-corrected FEI Titan3 60-300, operated at 60 kV. Delaminated flakes, i.e. isolated substantially two-dimensional layers, were dispersed onto a standard holey amorphous carbon support films suspended by a Cu grid.

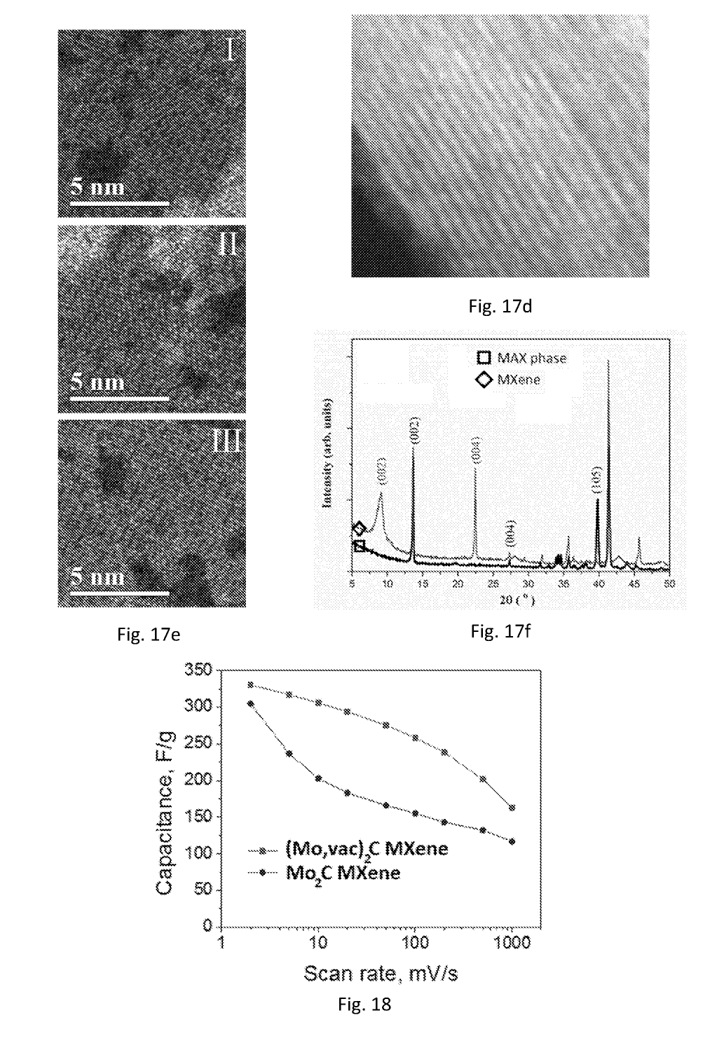

FIG. 17a constitutes a STEM photograph of a side view of a nanolaminated material with traditional structure for comparison, the nanolaminated material constituting Mn₂GaC. FIG. 17b constitutes a STEM photograph of a side view of the nanolaminated material (Mo_{2/3}Sc_{1/3})₂AlC wherein it is clearly shown that there is in-plane chemical ordering. FIG. 17c constitutes STEM photographs of a top view (at different magnitudes, and partly filled in to visualise the structure) of the substantially two-dimensional material obtained from the nanolaminated material (Mo_{2/3}Sc_{1/3})₂AlC when etch using an etching solution comprising HF. On the left hand side of FIG. 17c, a single sheet of the substantially two-dimensional material is shown. As can be seen from FIG. 17c, the resulting two-dimensional material comprises vacancies in the former Sc sites and the vacancies are consequently ordered. The resulting substantially two-dimensional material may thus be described as (Mo_{2/3},η_{1/3})₂C wherein η constitutes a vacancy. Etching of (Mo_{2/3}Sc_{1/3})₂AlC in a solution comprising LiF+HCl also resulted in a substantially two-dimensional material (Mo_{2/3},η₂₃)₂C wherein η constitutes a vacancy

FIG. 17d illustrates a STEM photograph of a side view of a stacked assembly (comprising a plurality of substantially two-dimensional layers) obtained from the nanolaminated material (W_{2/3}Sc_{1/3})₂AlC, i.e. where the individual layers have not been delaminated and isolated. An EDX analysis was also performed and showed no presence of Al or Sc. This means that all of the Al and Sc atoms are etched, and that a W-MXene with vacancies was obtained.

FIG. 17e illustrates STEM photographs of a top view of a substantially two-dimensional material obtained from the nanolaminated material (Mo_{2/3}Y_{1/3})₂AlC. Three different regions are chosen, (I) shows clearly the zig-zag pattern of vacancy ordering, and (111) shows an area of the substantially two-dimensional material which still contains Y. These results indicate that, by tailoring and controlling the etching process, it is possible to obtain either a MXene wherein the Mo and Y atoms are ordered, or a Mo-MXene comprising ordered vacancies.

FIG. 17f illustrate XRD spectra of the nanolaminated material (V_{2/3}Sc_{1/3})₂AlC and its resulting substantially two-dimensional material, i.e. MXene, after etching. The peak shift is the traditional approach to identify MXene formation and it is clearly shown that a MXene is obtained. However, results from XRD cannot determine if the Sc atoms remain in the substantially two-dimensional material or if vacancies have been obtained.

### Experimental Result 6

A previously known substantially two-dimensional material Mo₂C and the substantially two-dimensional material (Mo_{2/3},η_{1/3})₂C wherein η constitutes a vacancy was compared to each other in a number of tests. The substantially two-dimensional material (Mo_{2/3},η_{1/3})₂C was obtained from (Mo_{2/3}Sc_{1/3})₂AlC trough etching in a solution comprising HF.

In a battery test it was found that for similar lithiation capacity, (Mo_{2/3}η_{1/3})₂C stored >80% of its lithiation capacity at voltages below 0.5 V, compared to about 55% for Mo₂C. Hence, the presence of vacancies allow for more Li storage at low voltages, which is preferred for anodes.

A capacitance test was performed and the result is shown in FIG. 18. It can be seen that (Mo_{2/3}η_{1/3})₂C (in the figure denominated “(Mo,vac)₂C MXene”) resulted in superior performance compared to Mo₂C (in the figure denominated “Mo₂C MXene”). In fact, it is believed that the performance of (Mo_{2/3}η_{1/3})₂C is at the level of the best MXene performance to date compared to previous literature (see for example Ghidiu et al., 78, Nature, Vol. 516, 4 Dec. 2014). High capacitances were retained even at the fastest charging/discharging rates of 1000 mV/s.

Furthermore, transport measurements showed that the resistivity at room temperature for (Mo_{2/3}η_{1/3})₂C is four orders of magnitude lower than that of Mo₂C (3.2*10⁻⁵ vs. 0.6 Ω·m, respectively).

The tests above were performed in line with Halim et al., “Synthesis and Characterization of 2D molybdenum Carbide (MXene)”, Adv, Funct. Mater. 2016.

1. Nanolaminated material with the formula (M1_{x±β},M2_{y±ε})_{2-δ}Al_{1-α}C_{1±ρ}, wherein
β is 0 to ≤0.1,
ε is 0 to ≤0.1,
δ is 0 to ≤0.2,
α is 0 to ≤0.2,
ρ is 0 to ≤0.2,
x+y=1,
x is between 0.60 and 0.75, preferably wherein x is between 0.65 and 0.69,
M1 is a first transition metal and M2 is a second transition metal,
and wherein either
M1 is selected from a first group of transition metals consisting of Cr, Mo, Nb, Ta, Ti, V and W, and M2 is selected from a second group of transition metals consisting of Ce, Er, Hf, Ho, Sc, Y and Zr; or
M1 is Ti and M2 is selected from the group consisting of Nb, Ta, V and W; or
M1 is Sc and M2 is either Mo or W; or
M1 is Cr and M2 is Ta; or
M2 is Ti and M1 is selected from the group consisting of Cr, Nb, Ta and V.

2. Nanolaminated material according to claim 1, wherein M1 is selected from a first group of transition metals consisting of Cr, Mo, Nb, Ta, Ti, V and W, and M2 is selected from a second group of transition metals consisting of Ce, Er, Hf, Ho, Sc, Y and Zr.

3. Nanolaminated material according to claim 2, wherein the second group of transition metals consists of Ce, Er, Ho, Sc, Y and Zr, preferably wherein the second group of transition metals consists of Sc, Y and Zr.

4. Nanolaminated material according to any one of claims 2 and 3, wherein the first group of transition metals consists of Cr, Mo, Nb, V and W.

5. Nanolaminated material according to any one of the preceding claims, selected from the group consisting of
(Mo_{x±β},Sc_{y±ε})_{2-δ}Al_{1-α}C_{1±ρ},
(Mo_{x±β},Y_{y±ε})_{2-δ}Al_{1-α}C_{1±ρ},
(W_{x±β},Sc_{y±ε})_{2-δ}Al_{1-α}C_{1±ρ}, and
(V_{x±β},Sc_{y±ε})_{2-δ}Al_{1-α}C_{1±ρ}.

6. Nanolaminated material according to any one of the preceding claims wherein x is ⅔.

7. Nanolaminated material according to claim 1, wherein M1 is Ti and M2 is selected from the group consisting of Ce, Er, Hf, Ho, Nb, Sc, Ta, V, W, Y and Zr.

8. Nanolaminated material according to claim 1, wherein M1 is Sc and M2 is either Mo or W, and x is from 0.60 to 0.67, preferably wherein x is 0.60.

9. Process for manufacturing a material comprising at least one layer constituting a substantially two-dimensional array of crystal cells, the process comprising the following steps:
a. preparing a nanolaminated material with the formula (M1_{x±β},M2_{y±ε})_{2-δ}Al_{1-α}C_{1±ρ} according to any one of claims 1 to 7,
b. selectively etching the nanolaminated material so as to remove substantially all of the Al atoms and optionally substantially all of the M2 atoms, thereby obtaining a plurality of substantially two-dimensional layers each having a formula (M1_{x±β},M2_{y±ε})_{2-δ}Al_{1-α}C_{1±ρ} wherein η is either M2 or a vacancy, and wherein each substantially two-dimensional layer comprises a surface termination Tₛ resulting from the etching, and
c. optionally thereafter isolating at least one first layer of the plurality of substantially two-dimensional layers.

10. Process according to claim 9, wherein, in the nanolaminated material with the formula (M1_{x±β},M2_{y±ε})_{2-δ}Al_{1-α}C_{1±ρ}, M1 is selected from the first group of transition metals consisting of Cr, Mo, Nb, Ta, Ti, V and W, and M2 is selected from the second group of transition metals consisting of Ce, Er, Hf, Ho, Sc, Y and Zr.

11. Process according to claim 10, wherein, in the nanolaminated material with the formula (M1_{x±β},M2_{y±ε})_{2-δ}Al_{1-α}C_{1±ρ}, M2 is either Sc or Y, and the process further comprises either in step b. or in a separate step, selectively etching so as to remove M2 atoms from the nanolaminated material, thereby obtaining a material comprising at least one layer constituting a substantially two-dimensional array or crystal cells, the at least one first layer comprising ordered vacancies.

12. Process according to any one of claims 9 and 10, wherein, in the nanolaminated material with the formula (M1_{x±β},M2_{y±ε})_{2-δ}Al_{1-α}C_{1±ρ}, M2 is Ce, Er, Hf, Ho or Zr, and
wherein, in the plurality of substantially two-dimensional layers each having a formula (M1_{x±β},η_{y±ε})_{2-δ}C_{1±ρ} obtained in step b., q is M2.

13. A substantially two-dimensional material comprising a layer having an empirical formula (M1_{x±β},η_{y±ε})_{2-δ}C_{1±ρ} and constituting a substantially two-dimensional array of crystal cells, wherein
β is 0 to ≤0.1,
ε is 0 to ≤0.1,
δ is 0 to ≤0.2,
ρ is 0 to 0.2,
x+y=1,
x is between 0.60 and 0.75, preferably wherein x is between 0.65 and 0.69
M1 and η are arranged within the crystal cells such as together forming an essentially octahedral array and C is positioned within said essentially octahedral array,
η is either M2 or a vacancy,
and wherein either:
M1 is selected from a first group of transition metals consisting of Cr, Mo, Nb, Ta, Ti, V and W, and η is a vacancy; or
M1 is selected from a first group of transition metals consisting of Cr, Mo, Nb, Ta, Ti, V and W, η is M2, and M2 is selected from a group consisting of Ce, Er, Hf, Ho and Zr; or
M1 is Ti, η is M2, and M2 is selected from the group consisting of Nb, Ta, V and W; or
M1 is Cr, η is M2, and M2 is Ta; or
η is M2, M2 is Ti, and M1 is selected from the group consisting of Cr, Nb, Ta and V.

14. A substantially two-dimensional material according to claim 13, wherein x is ⅔.

15. A substantially two-dimensional material according to any one of claims 13 and 14, wherein the layer has a formula selected from the group consisting of:
(Mo_{x±β},η_{y±ε})_{2-δ}C_{1±ρ} wherein η is a vacancy or Y;
(W_{x±β},η_{y±ε})_{2-δ}C_{1±ρ} wherein η is a vacancy; and
(V_{x±β},η_{y±ε})_{2-δ}C_{1±ρ} wherein η is a vacancy.

16. A substantially two-dimensional material according to any one of claims 13 and 14, wherein the layer has the formula (M1_{x±β},M2_{y±ε})_{2-δ}C_{1±ρ}, wherein M2 is either Ce, Er, Hf, Ho or Zr.

17. A substantially two-dimensional material according to any one of claims 13 to 16, wherein the layer has a first surface and a second surface and wherein the layer comprises a surface termination Tₛ.

18. A stacked assembly comprising a plurality of layers wherein at least one of the layers constitutes a substantially two-dimensional material according to any one of claims 13 to 17.

19. Energy storage device comprising a substantially two-dimensional material according to any one of claims 13 to 17.

20. A composite comprising a substantially two-dimensional material according to any one of claims 13 to 17.

21. Material comprising at least one layer constituting a substantially two-dimensional array of crystal cells, the material obtainable through the process according to any one of claims 9 to 12.
